(19) United States
(12) Patent Application Publication
(10) Pub. No.: US 2018/0357691 A1
(43) Pub. Date: Dec. 13, 2018

(54) Portable Method And System For Generating Market Value Vehicle Offers To Automotive Service Customers

(71) Applicants: Rachelle Samson Lucarelli, Ocean, NJ (US); Bruno Lucarelli, III, Ocean, NJ (US)

(72) Inventors: Rachelle Samson Lucarelli, Ocean, NJ (US); Bruno Lucarelli, III, Ocean, NJ (US)

(21) Appl. No.: 16/002,605

(22) Filed: Jun. 7, 2018

Related U.S. Application Data
(60) Provisional application No. 62/517,039, filed on Jun. 8, 2017.

(51) Int. Cl. G06Q 30/06; G06Q 30/02; G06K 9/32; G06K 9/22

(52) U.S. Cl. CPC G06Q 30/0611; G06Q 30/0278; G06F 3/1243; G06K 9/228; G06K 9/325

(57) ABSTRACT

A system and method are provided for providing a purchase transaction offer to a vehicle service customer. The system and method may scan a vehicle identification number and/or a vehicle license plate to obtain information about the vehicle, such as the year, make, and model. This information can then be used to generate an offer to purchase the vehicle. The offer may be provided in a printed form that is given to the vehicle owner during the vehicle intake process for servicing.

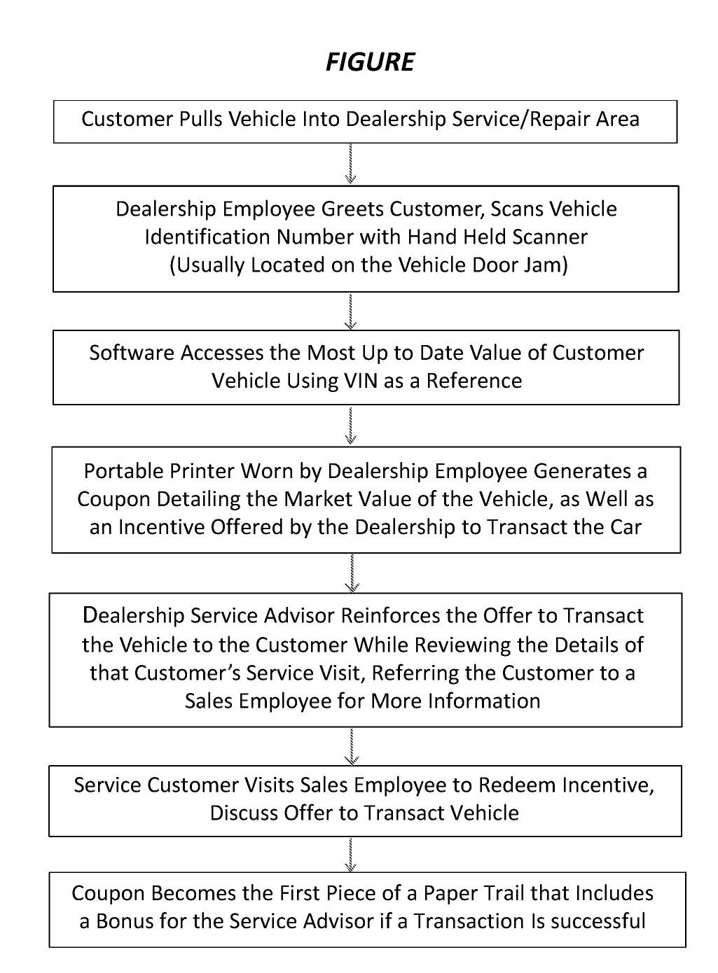

### CROSS-REFERENCE TO RELATED APPLICATIONS

This application claims benefit of U.S. Provisional Application No. 62/517,039, filed Jun. 8, 2017, which is hereby incorporated herein by reference in its entirety.

### FIELD OF THE INVENTION

This application relates to a method and system for providing an auto dealership customer with a coupon detailing immediate fair market value for their vehicle to be repaired or serviced. The coupon can be generated via a portable printer or a centralized printer. Particularly, the method utilizes a proprietary software system to access an external database with the result of creating a coupon via a hand-held scanner and a portable, wearable printer that instantly offers a service customer both the fair market value as well as an incentive to discuss the sale of the vehicle to be repaired or serviced with the dealership sales department that same day. More particularly, a method and system are provided to convert a service repair customer into a sales prospect. Specifically, the method and system relate to a novel internet based technique and sales process that will allow for the dealership to determine that customer's viability as a possible sales prospect through a predetermined list of desired vehicles, and to offer a fair price for that customer's vehicle to be repaired or serviced. The invention is also further applicable to integrate data related to that customer's financial eligibility, credit history, history with that dealership and other pertinent data regarding the transaction of the vehicle to be repaired or serviced.

### BACKGROUND OF THE INVENTION

Conventional methods and systems used in converting service repair vehicle customers into sales prospects use communication such as emails, direct mail and other non-personal methods to attempt to persuade that customer to transact their vehicle. While these techniques may be adequate to convey information, they are not adequate for the purposes of persuasion while the customer is on site at an auto dealership.

It is apparent that a need exists for a solution whereby a customer that brings their car to a dealership for repair is both informed of their car's current market value and incentivized to transact that vehicle while on site, dramatically increasing the likelihood of a transaction between buyer and seller. The present application is directed toward providing such a solution.

In one form, the application provides a method and a system, via a software solution, for the immediate conveyance, through a coupon generated by a portable printer, of an accurate market value and trade-in offer for the owner of a vehicle to be repaired or serviced by an automotive dealer.

According to one form, the application provides a commercially practicable, standardized sales process that will assure the most positive outcome for customers that are chosen for this service vehicle trade in program. According to one form, the application provides a system that utilizes a service vehicle customer's past financial history to facilitate a transaction.

In one form, the present system and method can be provided to share and otherwise utilize personally identifiable data from auto service customers through an interface with legacy systems and software. This includes information that will assist in the transactions, including but not limited to financial data on that vehicle, customer's personal information and other key data points.

### BRIEF DESCRIPTION OF THE DRAWINGS

A clear understanding of the key features of the system and method summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Accordingly:

The FIGURE is an illustration of the method and system of this invention showing a version of the proposed process and system.

### DETAILED DESCRIPTION

The method and the system described herein utilize an innovative concept of providing an immediate, physical coupon to a service or repair vehicle owner while on site at an automotive dealership that details the market value of their vehicle as well as an incentive from that dealer to transact the vehicle in a timely manner. In one form, this is achieved through a hand-held scanner application that utilizes an internet based proprietary software system and portable printer. In other forms, multiple scanners are used and send information to a centralized printer.

The software identifies the vehicle specifications through the car's Vehicle Identification Number (VIN) and prints a coupon with the vehicle's current market value and an incentive to discuss a possible transaction via a portable, wearable printer. In another form, the system can be used whereby the vehicle's license plate is used to identify the vehicle and then this information is used with either an internal database of license plates and VINs or an external database, such as obtained from a state's department of motor vehicles. This is done within minutes of arriving at the dealership, and during the process of checking the vehicle in to the store's service advisors. The dealership has the option of determining exactly which make, model and year of a desired vehicle. Only the service cars that fall within that predetermined subset are offered a coupon and incentive.

When the service advisor reviews the vehicle's needed repair or service, that advisor reinforces the offer presented to the customer. Ideally, the dealership will provide a cash incentive to each service advisor that successfully sends a service customer to the sales floor that results in a transaction. As the dealership service department often opens hours before the sales department, the store may make a salesperson available at earlier than usual hours to interface with prospects. When operated in the manner prescribed by the method stipulated herein, the coupon becomes the first article in a paper trail that leads to a possible transaction. This coupon determines which service advisor is awarded a cash incentive.

The method of this invention is particularly suited for high volume and high value auto dealerships, as both a large number of daily service vehicles and/or high resale values are the most positive contributing factors in predicting sales outcomes.

The system and method may also take into account a number of other parameters regarding the vehicle. For example, such parameters may include, but are not limited to, current mileage, trim level, options, etc. In one form, the system may prompt the user to input one or more of these parameters. In another form, one or more of these parameters, such as the trim level, may already be included in the database, such as if the vehicle has already been serviced at the dealer or had been sold by the dealer. Further, mileage information may also be estimated, such as from previous visits to the dealer and/or from other databases, such as emissions databases, external service databases, and the like.

As described herein, one form of the system may utilize a portable printer, such as a printer which may be worn or carried by the dealer employee that scans the vehicle. In another form, a centralized printer may be provided whereby multiple portable scanners may transmit data for printing.

The FIGURE is a flow diagram illustrating one form of the method and system. As shown in the FIGURE, a customer brings vehicle to service/repair staging area of auto dealership. Next, the dealership employee greets customer and uses hand-held device to scan vehicle identification number (usually on the door jamb of the vehicle). Once scanned, the system accesses on database, such as an online database, to retrieve the most current market value of the customer's vehicle, using the VIN as a reference.

If the vehicle falls within the predetermined parameters set by the dealership, a coupon detailing value of vehicle, as well as an incentive from the dealership, is generated and immediately handed to customer. Such parameters can include a variety of features such as the year of the vehicle, make/model of the vehicle, mileage, color, vehicle type (convertible, SUV, etc.), as well as other parameters.

Next, the dealership service advisor reviews the details of the customer's service visit and promotes the offer in the customer's coupon with a goal of pushing the customer to the sales department. If interested, the service/repair customer visits sales department to redeem the offer and discuss possible transaction of vehicle. In this form, the coupon becomes the first piece of a “paper trail” that determines the success of the program and track the payment of a “finder's fee” to the respective service advisor involved in the initial transaction.

It should be appreciated that in one form, the dealership service advisor may be the dealership employee approaching the service customer with an offer to purchase the service customer's vehicle. However, other dealership employees, such as a sales representative, manager, and the like, may also approach the service customer with the offer to purchase.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

What is claimed is:

1. A method for providing a purchase transaction offer to a vehicle service customer, the method comprising the steps of:
scanning the vehicle service customer's vehicle for at least one of a vehicle identification number and a license plate number;
searching a database for the vehicle's year, make, and model based on at least one of the vehicle identification number and license plate number;
printing an offer to purchase the vehicle from the vehicle service customer, the offer including an estimated purchase price of the vehicle which is based on the vehicle's year, make, and model.

2. The method of claim 1 further comprising the step of requesting a user to enter at least one of the mileage of the vehicle and the trim level of the vehicle.

3. The method of claim 1 further comprising the step of obtaining at least one of a last reported mileage of the vehicle and a trim level of the vehicle from a database.

4. The method of claim 1 wherein the scanning step is performed by a user with a hand-held scanner.

5. The method of claim 1 wherein the scanning step is performed by a scanner mounted to view the vehicle's license plate when the vehicle enters a service facility.

6. The method of claim 1 wherein the printing step is performed by a portable printer carried by a user.

7. The method of claim 1 wherein the printing step is performed by a remote printer.

8. The method of claim 1 further comprising the step of determining if the vehicle falls within predetermined criteria for the vehicle, the predetermined criteria including at least one of the year of the vehicle, make/model of the vehicle, mileage, color, and vehicle type.

9. A system for providing a purchase transaction offer to a vehicle service customer, the system comprising:
a scanner for scanning the vehicle service customer's vehicle for at least one of a vehicle identification number and a license plate number, the scanner in communication with at least one database containing the vehicle's year, make, and model based on at least one of the vehicle identification number and license plate number;
a processor configured to obtain an estimated purchase price from a database based on the vehicle's year, make, and model or to determine the estimated purchase price based on vehicle's year, make, and model;
a printer for printing an offer to purchase the vehicle from the vehicle service customer, the printed offer including the estimated purchase price of the vehicle.

10. The system of claim 9 wherein the processor receives information concerning at least one of the mileage of the vehicle and the trim level of the vehicle.

11. The system of claim 9 wherein obtains at least one of a last reported mileage of the vehicle and a trim level of the vehicle from a database.

12. The system of claim 9 wherein the scanner is a hand-held scanner.

13. The system of claim 9 wherein the scanner is mounted to view the vehicle's license plate when the vehicle enters a service facility.

14. The system of claim 9 wherein the printer is a portable printer configured to be carried by a user.

15. The system of claim 9 wherein the printer is a printer located remote from the scanner.
